(19) United States
(12) Patent Application Publication
(10) Pub. No.: US 2017/0171612 A1
(43) Pub. Date: Jun. 15, 2017

(54) AUDIO AND VIDEO PLAYING APPARATUS AND POWER SUPPLYING METHOD THEREOF

(71) Applicants: Le Holdings (Beijing) Co., Ltd., Beijing (CN); Le Shi Zhi Xin Electronic Technology (Tianjin) Limited, Tianjin (CN)

(72) Inventor: Wei LIU, Tianjin (CN)

(21) Appl. No.: 15/250,790

(22) Filed: Aug. 29, 2016

Related U.S. Application Data
(63) Continuation of application No. PCT/CN2016/088726, filed on Jul. 5, 2016.

(30) Foreign Application Priority Data
Dec. 14, 2015 (CN) 201510944256.2

(51) Int. Cl. H04N 21/443

(52) U.S. Cl. CPC H04N 21/4436

(57) ABSTRACT

An audio and video playing apparatus and a power supplying method thereof are disclosed. The audio and video playing apparatus includes: a main processor system, a display system and an audio system; the apparatus further comprising a first power module configured to supply power for the main processor system, and a second power module configured to supply power for the display system; wherein the first power module is connected to the second power module via a switch control circuit, and the first power module configured to supply power for the main processor system controls, via the switch control circuit, the second power module configured to supply power for the display system. The main processor system and the display system of a split tv are each powered by the audio and video playing apparatus and the power supplying method thereof provided in the embodiment of the present disclosure, such that the main processor system of the split tv may be individually used when a power adapter is not needed, and a utilization rate of the main processor system of the split tv may be increased.

### CROSS REFERENCE TO RELATED APPLICATIONS

This application is a continuation of PCT Application No. PCT/CN2016/088726 filed on Jul. 5, 2016, which claims priority to Chinese Patent Application No. 201510944256.2, filed before State Intellectual Property Office of the P. R. China on Dec. 14, 2015 and entitled “AUDIO AND VIDEO PLAYING APPARATUS AND POWER SUPPLYING METHOD THEREOF”, the entire contents of which are incorporated herein by reference.

### TECHNICAL FIELD

The present disclosure relates to the technical field of multimedia, and more particularly, to an audio and video playing apparatus and a power supplying method thereof.

### BACKGROUND

An audio and video playing apparatus (for example, a smart television) is a new product formed based on developments of the Internet, and one objective of the audio and video playing apparatus is to bring more convenient experience to a user. At present, the audio and video playing apparatus has become a fashionable trend of televisions. The smart television is a new television product that has a full open platform and is equipped with an operating system. With such a television, the user may install and uninstall all types of disclosures when he or she watches programs of an ordinary television, and may continuously expand and upgrade the functions. The smart television is capable of unceasingly bringing to the user abundant personalized experience which is different from that of a cable digital television receiver (a set-top box).

In the related art, a main board and a display system of a processor in a smart video system solution are integrally assembled. If the system needs to be upgraded, a housing needs to be disassembled to take out an inner main board. Such that, operations are complicated, and cost for upgrade is high. However, cost of simply replacing a whole machine is high.

As a new form of a smart television product, a split tv has gradually used by a television research and development manufacturers. The features of the split tv lie in that a video system is separated from a display system, and a main system is upgraded with no need of exchanging the display system, cost of upgrading the system is reduced, and upgrade is convenient. Two independent portions of the split tv need to be separately powered; that is, the independent main system is powered, and at the same time, the independent display system is powered.

FIG. 1 is a schematic structural diagram of a power supplying scheme for a split tv in the related art. As illustrated in FIG. 1, the power supplying scheme of the split tv in the related art is that: a display system end is integrated with a power board, and a direct power line is led from the power board of the display system to power supplying for the main system. In the related art, an alternating input power board is used to power supplying for the display system and the main system, to achieve an objective of energy saving. During the implementation of the present disclosure, the inventors have found that the prior art has at least the following problem: in the related art, if the main system needs to be individually used, an additional power adapter needs to be provided for supplying power for the main system, which increases cost of a customer, thereby resulting in a poor user experience, and reducing desire for using an audio and video playing apparatus.

### SUMMARY

The present disclosure provides an audio and video playing apparatus and a power supplying method thereof, such that a main processor is capable of working independently of a display system, with no need of a power adapter.

An embodiment of the present disclosure provides an audio and video playing apparatus, including:

a main processor system, a display system and an audio system; the apparatus further comprising a first power module configured to supply power for the main processor system, and a second power module configured to supply power for the display system; wherein

the first power module is connected to the second power module via a switch control circuit, and the first power module configured to supply power for the main processor system controls, via the switch control circuit, the second power module configured to supply power for the display system.

An embodiment of the present disclosure provides a power supplying method of an audio and video playing apparatus, including:

controlling, by a switch control circuit using a direct current output by a third power module, a second power module to be enabled or disabled, wherein a first power module supplies power for a main processor system, and the second power module supplies power for a display system.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram of a power supplying scheme for a split tv in the related art;

FIG. 2 is a schematic structural diagram illustrating an audio and video playing apparatus according to an embodiment the present disclosure; and

FIG. 3 is a schematic structural diagram illustrating an audio and video playing apparatus according to an embodiment the present disclosure.

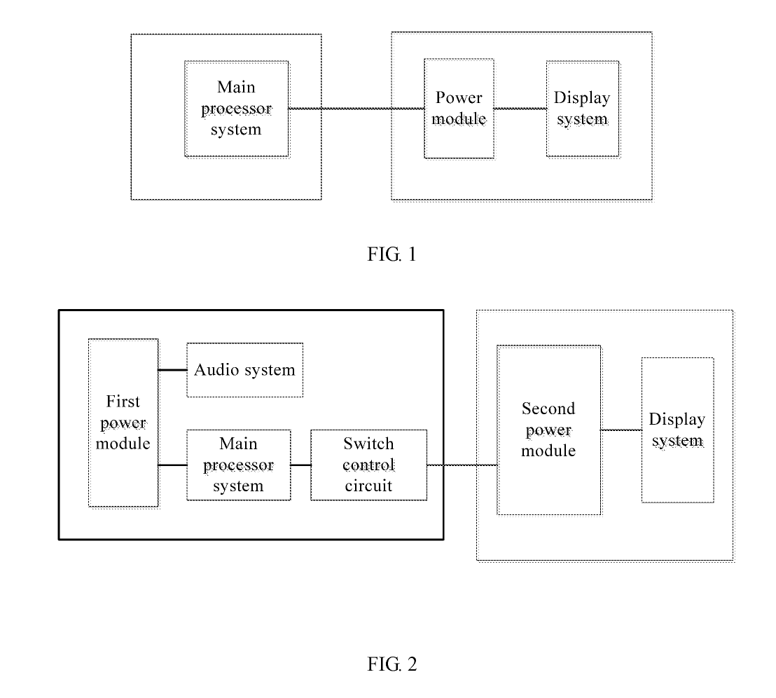

### DETAILED DESCRIPTION

To make the objectives, technical solutions and advantages of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

FIG. 2 is a schematic structural diagram illustrating an audio and video playing apparatus according to an embodiment the present disclosure. As illustrated in FIG. 2, the audio and video playing apparatus includes: a main processor system, a display system and an audio system; wherein the apparatus further includes a first power module configured to supply power for the main processor system, and a second power module configured to supply power for the display system; wherein

the first power module is connected to the second power module via a switch control circuit, and the first power module configured to supply power for the main processor system controls, via the switch control circuit, the second power module configured to supply power for the display system.

Specifically, the audio and video playing apparatus is connected to a main signal source and/or an external signal source and the display system. The main processor system is capable of receiving a main video signal from a main signal source, and has a screen display menu selection function. The audio and video playing apparatus may be externally connected to an audio and video output device such as a DVD player or a set top box, uses the audio and video output device as an external signal source, and receives the audio and video signal from the external audio and video output device. The external signal source may be but not limited to a television signal source, a signal source from the Internet, or a locally downloaded signal source, and is the audio and video signal source of an audio and video apparatus externally connected to the audio and video playing device. The audio system and the display system may be but not limited to a multimedia apparatus that is pertained by the audio and video playing apparatus or a multimedia apparatus that is externally connected to the audio and video playing apparatus in a detachable format.

Input of the first power module is a 220 V alternating current, and output of the first power module is the direct current. The switch control circuit may be specifically a switch, and the switch may be controlled to be enabled or disabled, thereby cutting off or connecting the circuit. It may be understood that when the switch is cut off when the switch is switched on, and when the switch is switched off, the circuit is connected. The direct current output by the first power module is connected to the second power module via the switch control circuit. Input of the first power module is a 220 V alternating current, and output of the first power module is the direct current.

Output of the first power module is input of the power of the main processor system, and the output of the second power module is input of the power supply of the display system.

In the embodiment of the present disclosure, a main processor system and a display system of a split tv are each powered by an independent power supply, such that the main processor system of the split tv may be individually used when a power adapter is not needed, and a utilization rate of the main processor system of the split tv may be increased. In the embodiment of the present disclosure, a first power module supplying power for the main processor system controls, via a switch control circuit, a second power module supplying power for the display system, and may further control the second power module to be enabled or disabled, such that a utilization rate of power energy is further improved.

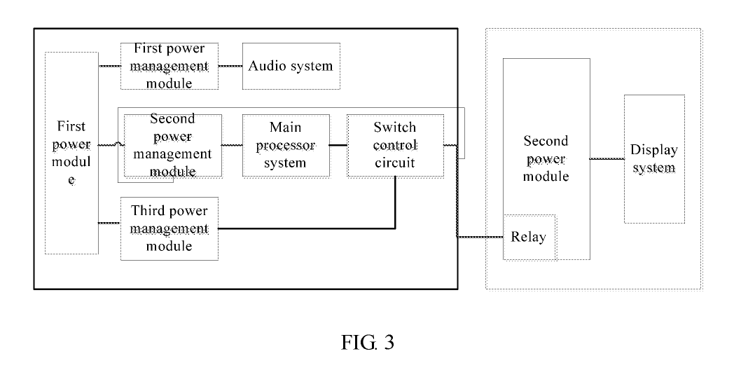

FIG. 3 is a schematic structural diagram illustrating an audio and video playing apparatus according to an embodiment the present disclosure. As illustrated in FIG. 3, the audio and video playing apparatus includes: a main processor system, a display system and an audio system; wherein the apparatus further includes a first power module configured to supply power for the main processor system, and a second power module configured to supply power for the display system; wherein

the first power module is connected to the second power module via a switch control circuit, and the first power module configured to supply power for the main processor system controls, via the switch control circuit, the second power module configured to supply power for the display system.

The audio and video playing apparatus further includes a first power management module, wherein one end of the first power management module is connected to the first power module, and the other end of the first power management module is connected to the audio system.

Power management refers to how to effectively allocate the power to different components of the system. The power management is very important for a mobile device depending on battery power. By reducing energy consumption of the components in idle time, a good power management system can prolong the life time of the battery by one-fold or three-fold. A power management technology also refers to a power control technology, pertains to a category of a power electronic technology, and is an edge crossing technology integrated with power transformation, modern electronics, network building, automatic control and the like. The power management module is generally configured to perform power management on a circuit, thereby improving accuracy of power inputs, reducing the power consumption, and increasing efficiency.

In an embodiment of the present disclosure, the audio and video playing apparatus further includes a first power management module, wherein one end of the first power management module is connected to the first power module, and the other end of the first power management module is connected to the audio system. That is, an external 220 V alternating current power is input into the first power module, and a direct current is output from the first power module, wherein the audio system is powered by the direct current. To provide accurate and stable voltage for the audio system, the direct current output from the first power module is input into the audio system again through the first power management module to supply power for the audio system.

In an embodiment of the present disclosure, an audio system may be accurately powered by configuring a first power management module, and the audio system and a main processor system share the same power supply, that is, a first power management module, which enables the main processor system and the audio system of a split tv to individually work. For example, when a user only wants audio data, the user may enable the main processor system and the audio system to work, with no need of enabling the display system to work. In an embodiment of the present disclosure, the audio and video playing apparatus is capable of providing multiple disclosure modes for the user, increasing a utilization rate and utilization fun of the audio and video playing apparatus, and enhancing user experience.

Specifically, in the embodiment of the present disclosure, the audio and video playing apparatus may further include a second power management module, wherein one end of the second power management module is connected to the first power module, and the other end of the second power management module is connected to the main processor system.

In an embodiment of the present disclosure, the audio and video playing apparatus further includes a second power management module, wherein one end of the second power management module is connected to the first power module, and the other end of the second power management module is connected to the main processor system. That is, an external 220 V alternating current power is input into the first power module, and a direct current is output from the first power module, wherein the main processor system is powered by the direct current. To provide accurate and stable voltage for the main processor system, the direct current output from the first power module is input into the main processor system again through the first power management module to supply power for the main processor system.

In an embodiment of the present disclosure, a display system may be accurately powered by configuring a second power management module, and the display system and a main processor system of a split tv are each powered by an independent power supply, such that the main processor system of a split tv may be individually used in the case of no need of a power adapter, and a utilization rate of the main processor system of the split tv may be increased. In an embodiment of the present disclosure, a first power module supplying power for the main processor system controls, via a switch control circuit, a second power module supplying power for the display system, and may further control the second power module to be enabled or disabled, such that a utilization rate of power energy is further improved.

Specifically, in the embodiment of the present disclosure, the apparatus may further include a third power management module, wherein one end of the third power management module is connected to the first power module, the other end of the third power management module is connected to one end of the switch control circuit, the other end of the switch control circuit is connected to the second power module, and one end of the switch control circuit is connected to the main processor system.

In the embodiment of the present disclosure, the audio and video playing apparatus further includes a third power management module, wherein one end of the third power management module is connected to the first power module, the other end of the third power management module is connected to one end of the switch control circuit, and the other end of the switch control circuit is connected to the second power module. It may be understood that a connection sequence of the third power management module, the first power module, the switch control circuit, and the second power module is that the first power module is connected to the third power management module, the third power management module is connected to the switch control circuit, and the switch control circuit is connected to the second power module. That is, an external 220 V alternating current power is input into the first power module, and direct current is output from the first power module. To provide accurate and stable voltage, the direct current output from the first power module passes through the third power management module, passes through the switch control circuit, and finally reaches the second power module. In an embodiment, the other end of the switch control circuit is connected to the second power module, and the switch control circuit to be enabled or disenabled is controlled by a control signal sent by the main processor system. Therefore, in an embodiment of the present disclosure, the main processor system controls the switch control circuit, and controls, with the third power management module, the second power module to supply power for the display system. In the embodiment of the present disclosure, a display system may be accurately powered by configuring a third power management module, a main processor system controls a switch control circuit, and controls, with the third power management module, a second power module to supply power for the display system., which further improves control fineness degree for supplying power for the display system. In the embodiment of the present disclosure, the main processor system and a video system are each powered by an independent power supply, which enables the main processor system of a split tv to individually work, thereby increasing a utilization rate and utilization fun of an audio and video playing apparatus, and enhancing user experience. Specifically, in an embodiment of the present disclosure, the audio and video playing apparatus further includes a relay, wherein the relay is connected to the second power module to control the second power module to be enabled or disabled. It may be understood that the relay implements the function of a switch, and when being cut off or connected, the relay may control the second power module to be enabled or disabled. When being cut off, the relay controls the second power module to be disabled, and the display system is not powered at this moment. However, when being connected, the relay controls the second power module to be enabled, and the display system is powered at this moment.

In the embodiment of the present disclosure, the display system may be accurately powered by configuring the relay.

The first power module is an alternating-current input direct-current output power supply, and the second power module is an alternating-current input direct-current output power supply. Specifically, input power of the first power module is alternating current power supply, supply voltage is 220 V, and output power is a direct current complying with requirements of an audio and video playing apparatus. Similarly, input power of the second power module is alternating current power supply, supply voltage is 220 V, and output power is a direct current complying with requirements of an audio and video playing apparatus.

Specifically, in an embodiment of the present disclosure, the main processor system is connected to the switch control circuit via a GPIO pin. A general purpose input output (GPIO), or a bus extender simplifies extension of an I/O port by using industrial standard an inter-integrated circuit (I2C), a system management bus (SMBus) or a serial peripheral interface (SPI). When a microcontroller or a chipset has no sufficient I/O ports, or when the system needs to use remote serial to communicate or control, the GPIO products are capable of providing additional controlling and monitoring functions. Each GPIO port may separately configure inputs or outputs via software. A GPIO product line of the Maxim includes the GPIO of eight to twenty-eight ports, provides push-pull outputs or open drain outputs, and provides a 3 mm×3 mm quad flat no-lead package (QFN). It may be understood that the QFN is one of the surface mounting packages, which is generally referred to as LCC. The QFN is the name specified in Japanese electronic machinery industry association, which is not defined herein any further.

In the embodiment of the present disclosure, when the audio and video playing apparatus is in a standby state, the relay on the second power module of the display system is in a disconnected state, and the second power module is in an energy-saving state without outputting power. When a power key is pressed, the audio and video playing apparatus is in an operating state, the GPIO pin of the main processor system controls the key control circuit to be connected, a third power management module outputs control voltage to the relay on the second power module of the display system, the relay is connected, and the second power module supplies power for the display system to enable the display system to work properly.

The present disclosure provides a power supplying method of an audio and video playing apparatus, and the method includes:

controlling, by a switch control circuit using a direct current output by a first power module, a second power module to be enabled or disabled, wherein a first power module supplies power for a main processor system, and the second power module supplies power for a display system.

Specifically, the first power module is connected to the second power module via the switch control circuit, and the first power module supplying power for the main processor system controls the second power module supplying power for the display system via the switch control circuit.

Input of the first power module is a 220 V alternating current, and output of the first power module is a direct current. The switch control circuit may be specifically a switch, and the switch may be controlled to be enabled or disabled, thereby cutting off or connecting the circuit. It may be understood that when the switch is cut off, the electrically connection of the circuit is switched, and when the switch is connected, the circuit is connected. The direct current output by the first power module is connected to the second power module via the switch control circuit. Input of the first power module is a 220 V alternating current, and output of the first power module is the direct current.

Output of the first power module is input of the power of the main processor system, and the output of the second power module is input of the power of the display system.

In the embodiment of the present disclosure, a main processor system and a display system of a split tv are each powered by an independent power supply, such that the main processor system of the split tv may be individually used when a power adapter is not needed, and a utilization rate of the main processor system of the split tv may be increased. In the embodiment of the present disclosure, a first power module supplying power for the main processor system controls, via a switch control circuit, a second power module supplying power for the display system, and may further control the second power module to be enabled or disabled, such that a utilization rate of power energy is further improved.

Specifically, in the embodiment of the present disclosure, the main processor system sends a control signal to the switch control circuit to control the switch control circuit to be enabled or disabled, and further to control power supplying for the second power module.

The other end of the switch control circuit is connected to the second power module, and the switch control circuit to be enabled or disenabled is controlled by a control signal sent by the main processor system. Therefore, in an embodiment of the present disclosure, the main processor system controls the switch control circuit, and controls the second power module to supply power for the display system.

Specifically, in the embodiment of the present disclosure, the power supplying method of the audio and video playing apparatus further includes: sending a management signal of a third power management module to the second power module via the switch control circuit.

Specifically, the apparatus may further include the third power management module, wherein one end of the third power management module is connected to the first power module, the other end of the third power management module is connected to one end of the switch control circuit, the other end of the switch control circuit is connected to the second power module, and one end of the switch control circuit is connected to the main processor system.

In the embodiment of the present disclosure, the audio and video playing apparatus further includes a third power management module, wherein one end of the third power management module is connected to the first power module, the other end of the third power management module is connected to one end of the switch control circuit, and the other end of the switch control circuit is connected to the second power module. It may be understood that a connection sequence of the third power management module, the first power module, the switch control circuit, and the second power module is that the first power module is connected to the third power management module, the third power management module is connected to the switch control circuit, and the switch control circuit is connected to the second power module. That is, an external 220 V alternating current power is input into the first power module, and a direct current is output from the first power module. To provide accurate and stable voltage, the direct current output from the first power module passes through the third power management module, passes through the switch control circuit, and finally reaches the second power module. In the embodiment, the other end of the switch control circuit is connected to the second power module, and the switch control circuit to be enabled or disenabled is controlled by a control signal sent by the main processor system. Therefore, in the embodiment of the present disclosure, the main processor system controls the switch control circuit, and controls, with the third power management module, the second power module to supply power for the display system.

In the embodiment of the present disclosure, a display system may be accurately powered by configuring a third power management module, a main processor system controls a switch control circuit, and controls, with the third power management module, a second power module to supply power for the display system, which further improves control fineness degree of supplying power for the display system. In the embodiment of the present disclosure, the main processor system and a video system separately are each powered by an independent power supply, which enables the main processor system of a split tv to individually work, thereby increasing a utilization rate and utilization fun of an audio and video playing apparatus, and enhancing user experience.

Specifically, in the embodiment of the present disclosure, when the audio and video playing apparatus is in a standby state, the main processor system sends a control signal to control the switch control circuit to interrupt power supplying for the second power module.

More specifically, in the embodiment of the present disclosure, when the audio and video playing apparatus is in the standby state, the main processor system sends the control signal to control the switch control circuit to supply power for the second power module.

In addition, control of power may be performed by the first power management module. For example, one end of the first power management module is connected to the first power module, and the other end of the first power management module is connected to the audio system. That is, an external 220 V alternating current power supply is input into the first power module, and direct current is output from the first power module, wherein the audio system is powered by the direct power supply. To provide accurate and stable voltage for the audio system, the direct current output from the first power module is input into the audio system again through the first power management module to supply power for the audio system.

In the embodiment of the present disclosure, an audio system may be accurately powered by configuring a first power management module, and the audio system and a main processor system share the same power, that is, a first power management module, which enables the main processor system and the audio system of a split tv to individually work. For example, when a user only wants audio data, the user may enable the main processor system and the audio system to work, with no need of enabling the display system to work. In the embodiment of the present disclosure, the audio and video playing apparatus is capable of providing multiple disclosure modes for the user, thereby increasing a utilization rate and utilization fun of the audio and video playing apparatus, and enhancing user experience.

In addition, control of power may be performed by the second power management module. For example, one end of the second power management module is connected to the first power module, and the other end of the second power management module is connected to the main processor system. That is, an external 220 V alternating current power is input into the first power module, and a direct current is output from the first power module, wherein the main processor system is powered by the direct current. To provide accurate and stable voltage for the main processor system, the direct current output from the first power module is input into the main processor system again through the first power management module to supply power for the main processor system.

In the embodiment of the present disclosure, a display system may be accurately powered by configuring a second power management module, and the display system and a main processor system of a split tv are each powered by an independent power supply, such that the main processor system of the split tv may be individually used when a power adapter is not needed, and a utilization rate of the main processor system of the split tv may be increased. In the embodiment of the present disclosure, a first power module supplying power for the main processor system controls, via a switch control circuit, a second power module supplying power for the display system, and may further control the second power module to be enabled or disabled, such that a utilization rate of power energy is further improved.

In addition, power supplying for the video system by the second power module may be controlled by the relay. For example, the relay is connected to the second power module to control the second power module to be enabled or disabled. It may be understood that the relay implements the function of a switch, and when being cut off or connected, the relay may control the second power module to be enabled or disabled. When being cut off, the relay controls the second power module to be disabled, and the display system is not powered at this moment. However, when being connected, the relay controls the second power module to be enabled, and the display system is powered at this moment.

In the embodiment of the present disclosure, the display system may be accurately powered by configuring the relay.

Specifically, the main processor system further controls the switch control circuit via the GPIO pin, thereby controlling power supplying for the video system by the second power module.

In the embodiment of the present disclosure, when the audio and video playing apparatus is in a standby state, the relay on the second power module of the display system is in a disconnected state, and the second power module is in an energy-saving state without outputting power. When a power key is pressed, the audio and video playing apparatus is in an operating state, the GPIO pin of the main processor system controls the key control circuit to be connected, a third power management module outputs control voltage to the relay on the second power module of the display system, the relay is connected, and the second power module supplies power for the display system to enable the display system to work properly.

The above described apparatus embodiments are merely for illustration purpose only. The modules which are described as separate components may be physically separated or may be not physically separated, and the components which are illustrated as modules may be or may not be physical modules, that is, the components may be located in the same position or may be distributed into a plurality of network modules. A part or all of the modules may be selected according to the actual needs to achieve the objectives of the technical solutions of the embodiments. Persons of ordinary skill in the art may understand and implement the present disclosure without paying any creative effort.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. An audio and video playing apparatus, comprising: a main processor system, a display system and an audio system; the apparatus further comprising a first power module configured to supply power for the main processor system, and a second power module configured to supply power for the display system;
the first power module is connected to the second power module via a switch control circuit, and the first power module configured to supply power for the main processor system controls, via the switch control circuit, the second power module configured to supply power for the display system.

2. The apparatus according to claim 1, further comprising, a first power management module, wherein one end of the first power management module is connected to the first power module, and the other end of the first power management module is connected to the audio system.

3. The apparatus according to claim 1, further comprising, a second power management module, wherein one end of the second power management module is connected to the first power module, and the other end of the second power management module is connected to the main processor system.

4. The apparatus according to claim 1, further comprising a third power management module, wherein one end of the third power management module is connected to the first power module, the other end of the third power management module is connected to one end of the switch control circuit, and the other end of the switch control circuit is connected to the second power module.

5. The apparatus according to claim 4, further comprising a relay, wherein the relay is connected to the second power module to control the second power module to be enabled or disabled.

6. The apparatus according to claim 1, wherein the first power module is an alternating-current input direct-current output power supply, and the second power module is an alternating-current input direct-current output power supply.

7. The apparatus according to claim 1, wherein the main processor system is connected to the switch control circuit via a GPIO pin.

8. A power supplying method of an audio and video playing apparatus, applied to a terminal, the method comprising:
controlling, by a switch control circuit using a direct current output by a third power module, a second power module to be enabled or disabled; supplying, by a first power module, power for a main processor system; and supplying, by the second power module, power for a di splay system.

9. The method according to claim 8, further comprising:
sending, by the main processor system, a control signal to the switch control circuit to control the switch control circuit to be enabled or disabled, to further control power supplying for the second power module.

10. The method according to claim 8, further comprising:
sending a management signal of the third power management module to the second power module via the switch control circuit.

11. The method according to claim 8, wherein when the audio and video playing apparatus is in a standby state, the main processor system sends a control signal to control the switch control circuit to interrupt power supplying for the second power module.

12. The method according to claim 8, wherein when the audio and video playing apparatus is in an operating state, the main processor system sends a control signal to control the switch control circuit to start power supplying for the second power module.
